(19) United States
(12) Patent Application Publication
(10) Pub. No.: US 2007/0228931 A1
(43) Pub. Date: Oct. 4, 2007

(54) White light emitting device

(75) Inventors: Bum Joon Kim, Seoul (KR); Hyun Gyu Shin, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/730,246

(22) Filed: Mar. 30, 2007

(30) Foreign Application Priority Data
Mar. 31, 2006 (KR) 10-2006-0029828

(51) Int. Cl. H01J 1/62; H01J 63/04

(52) U.S. Cl. 313/501

(57) ABSTRACT

A high quality white light emitting device capable of adjusting color balance easily. A substrate is provided. A light emitting structure includes an n-type semiconductor layer, an active layer and a p-type semiconductor layer sequentially formed on the substrate. Here, the light emitting structure emits primary radiation. Wavelength conversion film elements absorb a portion of the primary radiation and convert the absorbed portion of the primary radiation into secondary radiation of a different wavelength. The wavelength conversion film elements define an open region for selectively transmitting the primary radiation therethrough.

### CLAIM OF PRIORITY

This application claims the benefit of Korean Patent Application No. 2006-29828 filed on Mar. 31, 2006 in the Korean Intellectual Property Office, the disclosure of which is incorporated herein by reference.

### BACKGROUND OF THE INVENTION

1. Field of the Invention

The present invention relates to a white light emitting device, and more particularly, a high-quality white light emitting device using wavelength conversion film elements.

2. Description of the Related Art

A white light emitting diode (LED) device has found wide applications from backlight units, displays, traffic lights to general lightings. Especially, the white LED device is utilized as a backlight source of liquid crystal displays. Accordingly, there has-been a rising-demand for a small-sized white LED device consuming less power.

A conventional representative LED device can be realized by combining a blue light emitting diode and yellow phosphor. The blue light emitted from the blue LED excites the yellow phosphor to emit yellow light. The blue light and yellow light, if combined together, are perceived as white light by an observer. In this configuration which is in most wide use, the yellow phosphor has a high efficiency of about 90% and also the blue LED exhibits high efficiency. Thus this conventional LED device can be manufactured easily with high brightness. But disadvantageously, each LED device fails to produce uniform white light and suffers from color conversion according to an ambient temperature.

Alternatively, the white LED device can be achieved by combining the blue LED, a green LED and a red LED together. This configuration is free from light loss resulting from conversion by phosphor and ensures high color reproducibility. However, disadvantageously, the LED device configured as just described is costly and difficult to manufacture. Besides, any damage to even an LED chip renders white light unlikely to be produced.

Alternatively, the white LED device can be implemented by combining an ultraviolet ray LED and red/green/blue phosphor. This white LED device is easily manufacturable but the red phosphor has a low efficiency less than 40%. Thus, such a white LED device is degraded in color reproducibility and limited in high brightness.

Alternatively, the LED and a phosphor film can be combined to realize the white LED device. For example, the blue LED can be combined with a yellow phosphor film. U.S. Pat. No. 6,696,703 by Reigna B. Muelle-Mach at al. discloses a phosphor-converted LED having a phosphor film for converting primary emission form the LED. This configuration allows white light to be produced without a phosphor-containing mold resin. Therefore, the white LED device can be easily manufactured with smaller size. However, the phosphor film should be adjusted in its thickness considering light conversion efficiency to obtain desired white light. This renders color combination hardly controllable, thereby producing a non-uniform color.

FIG. 1 illustrates a conventional white light emitting diode (LED) device 10 employing a phosphor film. The white LED device 10 includes a light emitting structure 12 formed on a substrate 11 and a phosphor film 13 deposited on the light emitting structure 12. During operation of the LED device 10, the light emitting structure 12 emits blue light and the yellow phosphor film 13 absorbs a portion of the blue light and converts it into yellow light to emit. The blue light transmitting the phosphor film 13 combines with the yellow light emitted from the phosphor film 13 to produce white light W.

The white LED device 10 produces desired white light necessarily by adjusting thickness of the phosphor film considering light conversion efficiency. This renders it hard to combine or balance colors and produce a uniform color. Also, the white LED device described above is very likely to emit non-uniform white light due to different thickness of the phosphor film.

### SUMMARY OF THE INVENTION

The present invention has been made to solve the foregoing problems of the prior art and therefore an aspect of the present invention is to provide a high-quality white LED device capable of easily adjusting color balance and achieving uniform light emitting properties.

According to an aspect of the invention, the white light emitting diode device includes a substrate; a light emitting structure including an n-type semiconductor layer, an active layer and a p-type semiconductor layer sequentially formed on the substrate, the light emitting structure emitting primary radiation; and wavelength conversion film elements for absorbing a portion of the primary radiation and converting the absorbed portion of the primary radiation into secondary radiation of a different wavelength, wherein the wavelength conversion film elements define an open region for selectively transmitting the primary radiation therethrough. The primary radiation can be combined with the secondary radiation to form white light.

According to an embodiment of the invention, the wavelength conversion film elements are formed on the p-type semiconductor layer.

According to another embodiment of the invention, the wavelength conversion film elements are formed underneath the substrate.

According to further another embodiment of the invention, the wavelength conversion film elements are interposed between the light emitting structure and the substrate.

According to the invention, the wavelength conversion film elements is made of a wavelength convertible material selected from a group consisting of phosphor, metal silicate, oxide and semiconductor. For example, the phosphor may be made of YAG:Ce or TAG:Ce, and the semiconductor may be made of AlGaInP or ZnSe. Also, the metal silicate may be europium-silicate. The europium-silicate has a composition expressed by EuₓSi_{y}O_{z}, where 0<x<30, 0<y<30, and 0<z<30.

Preferably, the wavelength conversion film elements have a thickness that enables absorption of at least 90% of the primary radiation impinging thereon. In a case where the wavelength conversion film elements are made of europium-silicate, the wavelength conversion film elements have a thickness of 1 to 3 μm. The wavelength conversion film elements are made of a homogeneous material.

Preferably, the p-type semiconductor, the active layer and the n-type semiconductor layer are made of a nitride semiconductor. Also, the substrate is made of one selected from a group consisting of sapphire, SiC and GaN.

According to further another embodiment of the invention, the primary radiation comprises blue light, and the secondary radiation comprises light in a range from green to red wavelengths, or yellow light.

According to a preferred embodiment of the invention, the primary radiation comprises light in a range from blue to red wavelengths, and the secondary radiation comprises red light.

According to another preferred embodiment of the invention, white light is emitted through a top surface of the light emitting structure which opposes the substrate.

According to further another preferred embodiment of the invention, white light is emitted through an underside surface of the substrate which opposes the light emitting structure.

In this specification, a ‘nitride semiconductor’ designates a binary, ternary or quaternary compound semiconductor having a composition expressed by AlₓGa_{y}In_{(1-x-y)}N, where 0≦x≦1, 0≦y≦1, and 0≦x+y≦1.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a conventional white light emitting diode device;

FIG. 2 is a graph illustrating a photoluminescence spectrum of europium-silicate employed according to an embodiment of the invention;

FIGS. 3 to 10 are cross-sectional and upper plan views illustrating a white light emitting diode device according to various embodiments of the invention.

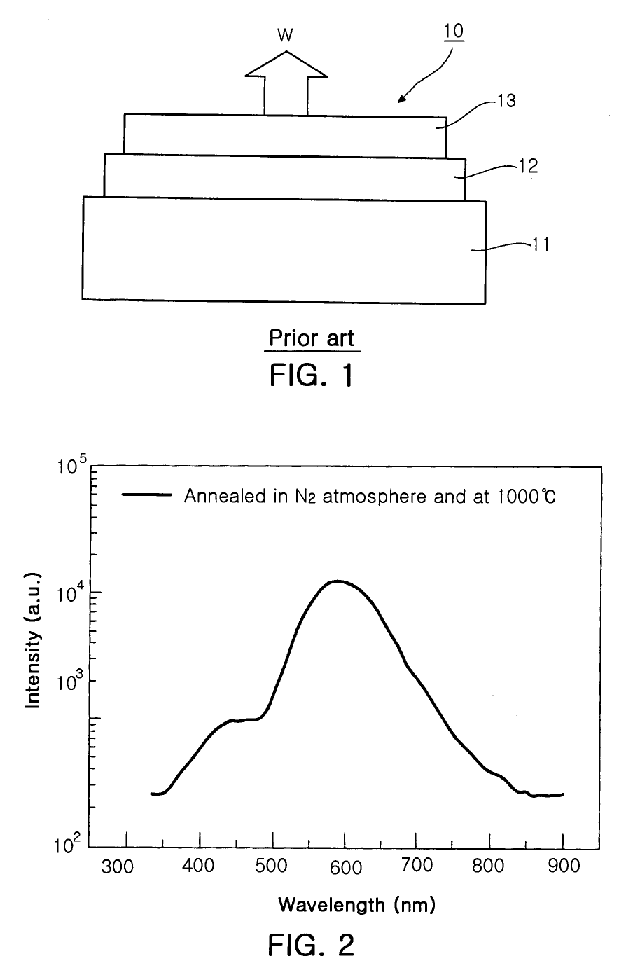

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference signs are used to designate the same or similar components throughout.

Wavelength conversion film elements according to the invention can be made of a wavelength convertible material selected from a group consisting of phosphor, metal silicate, oxide and semiconductor. FIG. 2 is a graph illustrating a photoluminescence spectrum of europium-silicate employed in wavelength conversion film elements according to an embodiment of the invention. Specifically, here, the europium-silicate is deposited by Eu₂O₃ and Si targets, and heat-treated to 1000° C. in N₂ atmosphere. This europium-silicate is a material having europium doped in silicate and has a composition expressed by EuₓSi_{y}O_{z}, where 0<x<30, 0<y<30, 0<z<30.

This photoluminescence spectrum is obtained by utilizing blue light or an ultraviolet ray as excitation light. As shown in FIG. 2, the europium-silicate emits light in a range from green to red wavelengths. The europium-silicate demonstrates the maximum intensity at a yellow wavelength of about 570 nm. Therefore, this europium-silicate is easily adoptable as phosphor (wavelength convertible material) which absorbs the blue light and converts it into light in a range from green to red wavelengths, or yellow light.

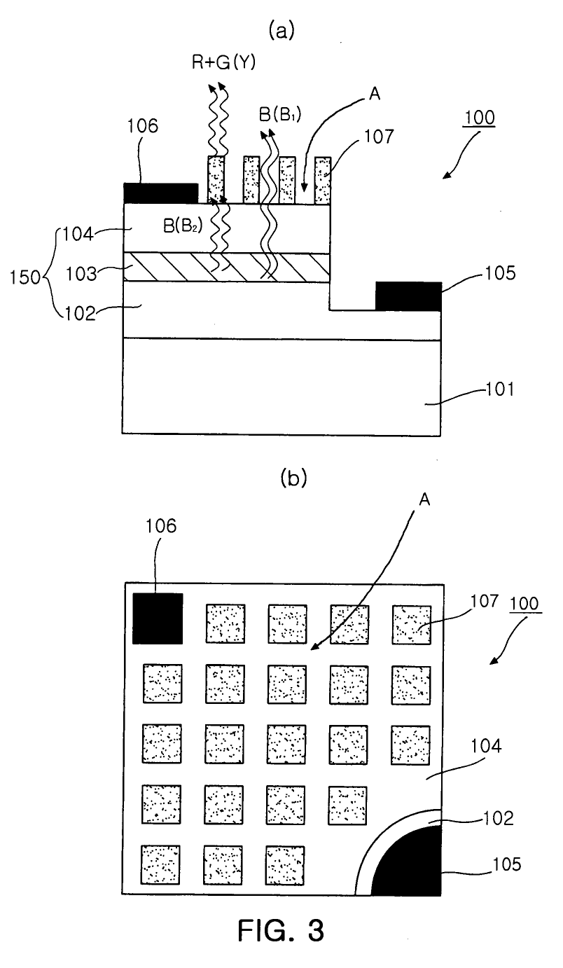

FIGS. 3(a) and 3(b) are schematic cross-sectional and upper plan views illustrating a white light emitting diode device according to an embodiment of the invention. Referring to FIGS. 3(a) and 3(b), the white light emitting diode device 100 includes a light emitting structure 150 formed on a substrate 101. The light emitting structure 150 includes an n-type semiconductor layer 102, an active layer 103, and a p-type semiconductor layer 104. The light emitting structure 150 is mesa-etched so that a portion of the n-type semiconductor layer 102 is exposed. An n-electrode 105 is formed on the exposed portion of the n-type semiconductor 102. Also, a p-electrode 106 is formed on the p-type semiconductor layer 104. Wavelength conversion film elements, i.e., a patterned wavelength conversion film 107 is formed on the p-type semiconductor layer 104. The wavelength conversion film elements 107 are formed to selectively expose the p-type semiconductor layer 104. In this device 100, white light (output light) is outputted through a top surface of the light emitting structure 150 which opposes the substrate 101. That is, light exits to a top surface of the p-type semiconductor layer.

Examples of the substrate 101 include a transparent sapphire substrate, a silicone carbide (SiC) substrate and a GaN substrate. The sapphire substrate is relatively cheap and stable at a high temperature, thereby widely used as a blue or green light emitting diode device.

The light emitting structure 150 maybe made of a nitride semiconductor material. The light emitting structure 150 of the nitride semiconductor is formed by a method selected from a group consisting of Metal Organic Chemical Vapor Deposition (MOCVD), Molecular Beam Epitaxy (MBE), and Hydride Vapor Phase Epitaxy (HVPE).

The active layer 103 emits light by recombination of electrons and holes, and preferably has a single or multiple quantum well structure. For example, the active layer 103 is made of a nitride semiconductor layer of e.g., InGaN, AlGaN, AlGaInN, or GaN. The active layer 103 emits blue light B, i.e., primary radiation.

The wavelength conversion film elements 107 are made of one selected from a group consisting of phosphor, metal silicate, oxide or semiconductor which can convert a wavelength of the primary radiation (blue light) B. The phosphor may adopt yellow phosphor such as YAG:Ce, and TAG:Ce. The semiconductor may be made of AlGaInP or ZnSe. The metal silicate may be made of europium-silicate having a composition of, for example, EuₓSi_{y}O_{z}, where 0<x<30, 0<y<30, and 0<z<30. To form the wavelength conversion film elements 107, a wavelength conversion film is formed by a method selected from a group consisting of sputtering, Chemical Vapor Deposition (CVD), Plasma Enhanced CVD, and Metal Organic CVD via a general deposition or growth apparatus, and then selectively etched.

The wavelength conversion film elements 107 are formed to selectively expose the p-type semiconductor layer 104. That is, the wavelength conversion film elements 107 define an open region for selectively transmitting the primary radiation B. Therefore, as the primary radiation (blue light) B travels from the light emitting structure 150 to the film elements 107, a portion B₁ of the primary radiation is emitted through a top surface of the p-type semiconductor layer 104 without penetrating the wavelength conversion film elements 107. Meanwhile, other portion B₂ of the primary radiation is absorbed in the wavelength conversion film elements 107. The portion B₂ of the primary radiation absorbed in the wavelength conversion film elements 107 is converted into secondary radiation by the film elements 107. The secondary radiation is yellow light Y or light R+G in a range from green to red wavelengths. The primary radiation B₂ is combined with the secondary radiation R+G or Y to produce white light.

The wavelength conversion film elements 107 may be made of a homogeneous material. Preferably, the wavelength conversion film elements 107 have a thickness that enables at least 90% of the primary radiation B₂ impinging thereon to be absorbed, more preferably at least 99%. In a case where the wavelength conversion film elements 107 are made of europium-silicate, preferably, the wavelength conversion film elements 107 may have a thickness ranging from 1 μm to 3 μm. The wavelength conversion film elements 107 are typically formed by Photo-Lithography.

As described above, the film elements 107 are thick enough to enable at least 90% of the primary radiation to be absorbed. Then color balance is easily controllable by adjusting a relative ratio between the area of the wavelength conversion film elements 107 and the area of the open region A in the film elements 107.

That is, increase in the total area of the film elements 107 relatively decreases the area of the open region A. This consequently reduces the primary radiation B₁ emitted to the open region A, and increases the primary radiation B₂ absorbed in the film elements 107. This as a result increases the secondary radiation R+G or Y obtained by the film elements 107. In contrast, decrease in the total area of the film elements 107 relatively increases the area of the open region A. This increases the primary radiation B₁ emitted to the open region A and reduces the primary radiation B₂ absorbed in the film elements 107. This as a result reduces the secondary radiation R+G or Y obtained by the film elements 107. Accordingly, color balance and color combination are easily controllable by adjusting a relative ratio between the area of the film elements 107 and the area of the open region A as described above.

Referring to FIG. 3(a), the primary radiation (blue light) B₁ transmitting the open region A is combined with the secondary radiation (light in a range from green to red wavelengths R+G) or yellow light Y obtained by the wavelength conversion film elements 107 to produce white light. A reflective layer (not illustrated) may be optionally formed underneath the substrate 101 to ensure more light to be emitted through a top surface of the p-type semiconductor layer 104, where light exits.

In FIG. 3(b) which is a modified example of FIG. 3, the wavelength conversion film elements may be formed in a location of the open region A and the open region may be formed in a location of the film elements 107. That is, in FIG. 3(b), the film elements 107 and the open region A may be located reversely. The film elements 107 can be shaped variously without being limited to a specific embodiment.

As described above, white light is attainable without a package for containing phosphor by adopting the wavelength conversion film. This reduces size of the white light emitting diode device. Moreover, color balance and color combination are easily controllable by adjusting a relative ratio between the area of the wavelength conversion film elements and the area of the open region. What is more, to form the wavelength conversion film elements, a wavelength conversion film is deposited and selectively etched, thereby advantageously simplifying a manufacturing process and reducing manufacturing costs of the device. In addition, to obtain desired white light, the wavelength conversion film is not adjusted in its thickness but a relative ratio between the area of the film elements and the area of the open region is adjusted. This assures each LED device to easily produce white light with uniform characteristics.

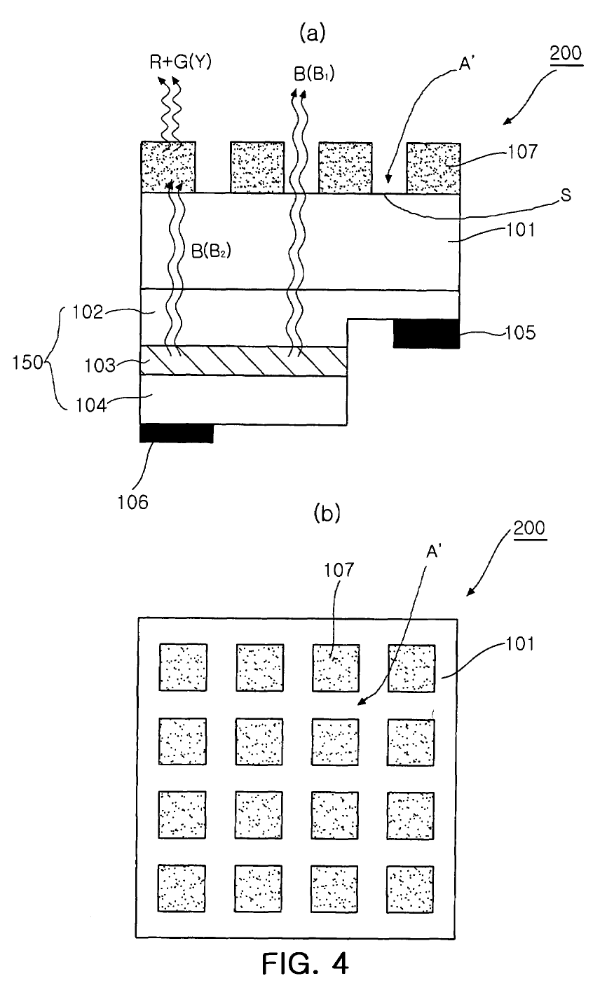

FIG. 4(a) and 4(b) are a schematic cross-sectional view and an upper plan view illustrating a white light emitting device 200 according to another embodiment of the invention, respectively. FIG. 4, which is a modified example of FIG. 3 is identical to FIG. 3 except that wavelength conversion film elements 107 are formed on an underside surface S of a substrate and light exits through the underside surface S of the substrate 101. To emit more light through the underside surface of the substrate 101, a reflective layer (not illustrated) may be optionally formed on the underside surface of the p-type semiconductor layer 104. Primary radiation B and secondary radiation R+G or Y of FIG. 4 are obtained substantially the same as in the embodiment of FIG. 3. That is, the primary radiation B is generated from an active layer 103 of a light emitting structure 150. The secondary radiation R+G or Y is obtained by the wavelength conversion film elements 107. A portion B₁ of the primary radiation (bluelight) B is emitted to open region A′ and other portion B₂ thereof is absorbed in the wavelength conversion film elements 107. The wavelength conversion film elements 107 convert the absorbed portion of the primary radiation B₂ into the secondary radiation of a different wavelength, i.e., light in a range from green to red wavelengths R+G or yellow light Y. The primary radiation B₁ transmitting the open region A′ is combined with the secondary radiation R+G or Y obtained by the wavelength conversion film elements 107 to form white light.

In FIG. 4(b), which is a modified example of FIG. 4, the wavelength conversion film elements may be formed in a location of the open region A′ and the open region may be formed in a location of the film elements 107.

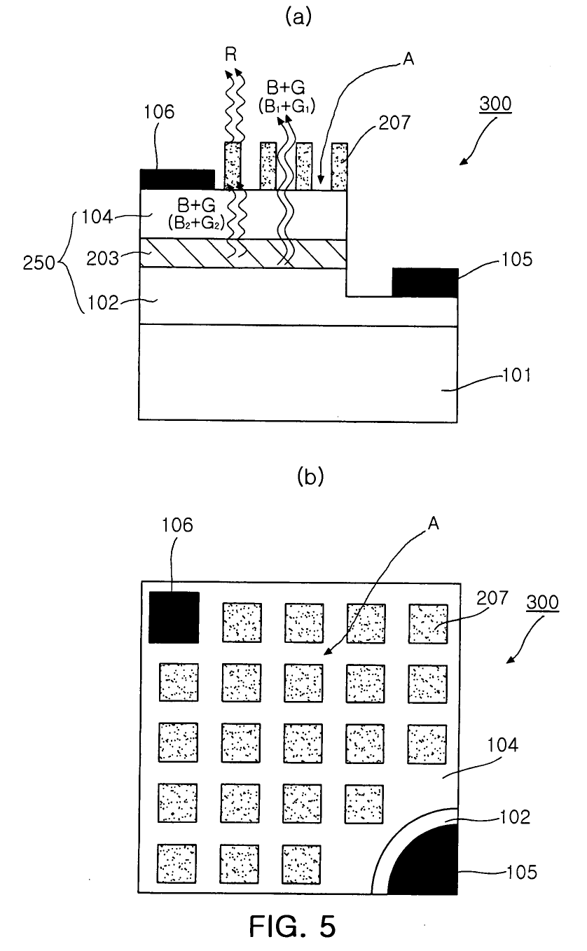

FIG. 5(a) and 5(b) are a schematic cross-sectional view and an upper plan view illustrating a white light emitting device 300 according to another embodiment of the invention, respectively. The embodiment of FIG. 5 is identical to that of FIG. 3 except that primary radiation generated from a light emitting structure 250 is light B+G in a range from blue to green wavelengths, and wavelength conversion film elements 207 convert the primary radiation B+G into secondary radiation which is red light R. Referring to FIGS. 5(a) and 5(b), a portion B₁+G₁ of the primary radiation B+G generated from an active layer 203 of a light emitting structure 250 is emitted to an open region A. Other portion B₂+G₂ of the primary radiation B+G is absorbed in the wavelength conversion film elements 207 and emitted as secondary radiation R. In the white light emitting device 300, the primary radiation B₁+G₁ is combined with the secondary radiation R to produce white light. A reflective layer (not illustrated) may be optionally formed underneath the substrate 101 to assure more light to be emitted through a top surface of a p-type semiconductor layer 104, where light exits.

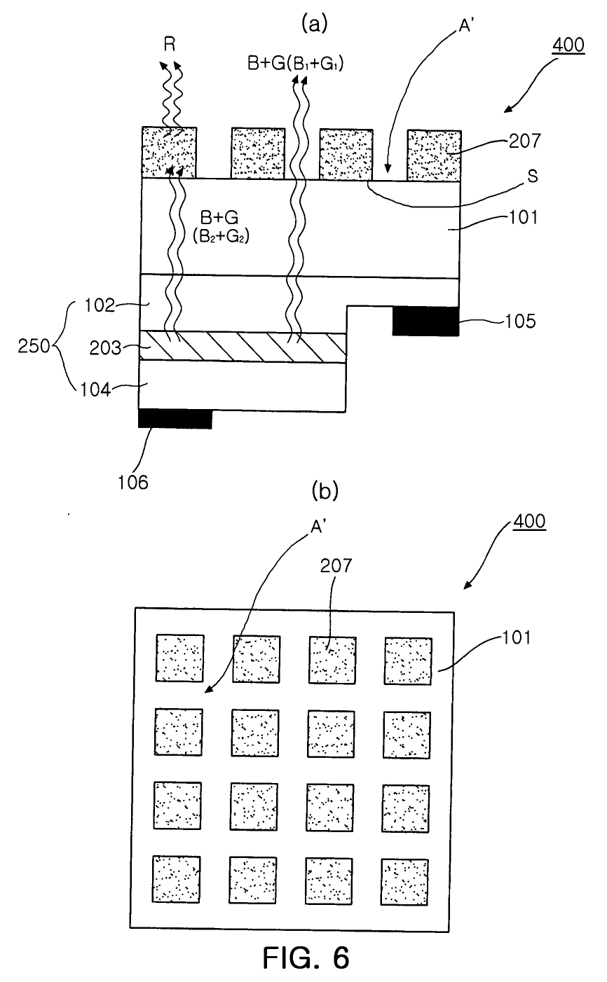

FIG. 6(a) and 6(b) are schematic cross-sectional view and an upper plan view illustrating a white light emitting device 400 according to another embodiment of the invention, respectively. FIG. 6, which is a modified example of FIG. 5, is identical to FIG. 5 except that wavelength conversion film elements 207 are formed on an underside surface S of a substrate 101 and light exits through the underside surface S of the substrate 101. A reflective layer (not illustrated) may be optionally formed underneath a p-type semiconductor layer 104 to allow more light to be emitted through the underside surface of the substrate 101. Primary radiation B+G and secondary radiation R are obtained substantially the same as in the embodiment of FIG. 5. That is, the primary radiation B+G is generated from a light emitting structure 250 and the secondary radiation R is obtained by the wavelength conversion film elements 207. A portion B₁+G₁ of the primary radiation B+G is emitted to an open region A′ and other portion B₂+G₂ thereof is absorbed in the wavelength conversion film elements 207 and converted into the secondary radiation R. In the white light emitting device 400, the primary radiation B₁+G₁ is combined with the secondary radiation R to form white light.

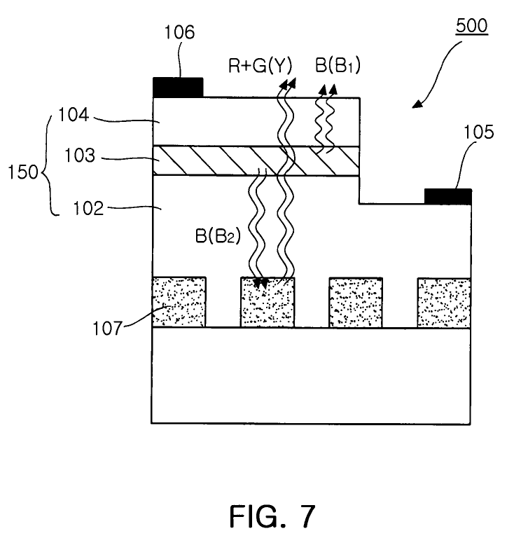

FIG. 7 is a cross-sectional view illustrating a white light emitting device 500 according to another embodiment of the invention. FIG. 7, which is a modified example of FIG. 3, is identical to FIG. 3 except that wavelength conversion film elements 107 are formed between a substrate 101 and a light emitting structure 150. Here light exits through a top surface of a p-type semiconductor layer 104. A reflective layer (not illustrated) may be optionally formed underneath the substrate 101 to ensure more light to be emitted. Primary radiation B and secondary radiation R+G or Y are obtained substantially the same as in the embodiment of FIG. 3. That is, a portion B₁ of the primary radiation (blue light) B is emitted through a top surface of a p-type semiconductor layer 104, and other portion B₂ thereof is absorbed in the wavelength conversion film elements 107. The wavelength conversion film elements 107 convert the absorbed portion B₂ of the primary radiation into the secondary radiation of a different wavelength, i.e., light in a range from green to red wavelengths (R+G) or yellow light Y. The secondary radiation R+G or Y is emitted through a top surface of the p-type semiconductor layer 104 without any change in the wavelength thereof. The primary radiation B₁ emitted through the top surface of the p-type semiconductor layer 104 is combined with the secondary radiation R+G or Y obtained by the wavelength conversion film elements 107, thereby producing white light.

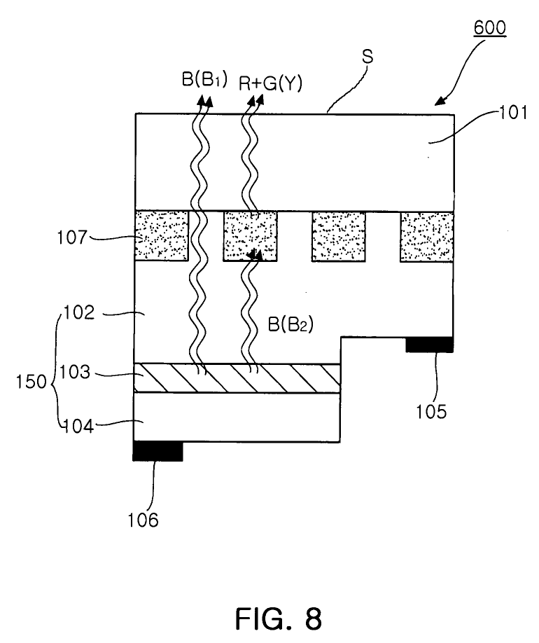

FIG. 8 is a schematic cross-sectional view illustrating a white light emitting device 600 according to further another embodiment of the invention. FIG. 8, which is a modified example of FIG. 7, is identical to FIG. 7 except that light exits through an underside surface S of a substrate 101. Primary radiation B and secondary radiation R+G or Y are obtained substantially the same as in the embodiment of FIG. 7. That is, the primary radiation B is generated from an active layer 103 of a light emitting structure 150 and the secondary radiation R+G or Y is obtained by wavelength conversion film elements 107. A portion B₁ of the primary radiation B is emitted through the underside surface S of the substrate 101, and other portion B₂ thereof is absorbed in the wavelength conversion film elements 107. The wavelength conversion film elements 107 convert the absorbed portion of the primary radiation B₂ into the secondary radiation of a different wavelength, i.e., R+G or Y. The secondary radiation R+G or Y is emitted through the underside surface S of the substrate without any change in the wavelength thereof. The primary radiation B₁ emitted through the underside surface S of the substrate 101 is combined with the secondary radiation R+G or Y obtained by the wavelength conversion film elements 107, thereby producing white light.

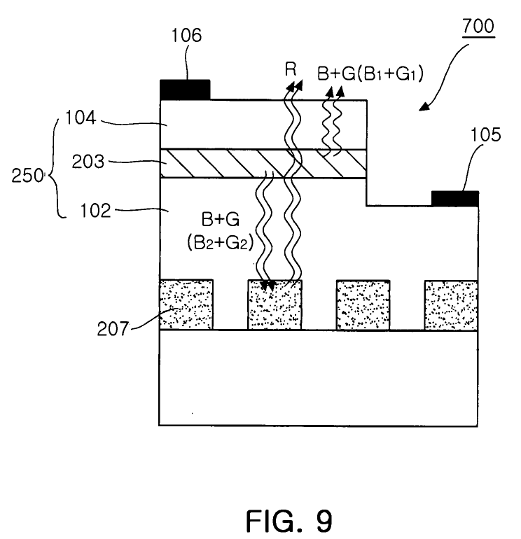

FIG. 9 is a schematic cross-sectional view illustrating a white light emitting device 700 according to further another embodiment of the invention. The embodiment of FIG. 9 is identical to that of FIG. 7 except that primary radiation generated from a light emitting structure 250 is light B+G in a range from blue to green wavelengths and wavelength conversion film elements 207 convert a portion of the primary radiation B+G into secondary radiation which is red light R. Referring to FIG. 9, a portion B₁+G₁ of the primary radiation B+G generated from an active layer 203 of a light emitting structure 250 is emitted through a top surface of a p-type semiconductor layer 104. Other portion B₂+G₂ of the primary radiation B+G is absorbed in the wavelength conversion film elements 207 and then emitted as secondary radiation R. In the white light emitting device 700, the primary radiation B₁+G₁ is combined with the secondary radiation R to produce white light. A reflective layer (not illustrated) may be optionally formed underneath the substrate 101 to allow more light to be emitted through the top surface of the p-type semiconductor layer 104 where light exits.

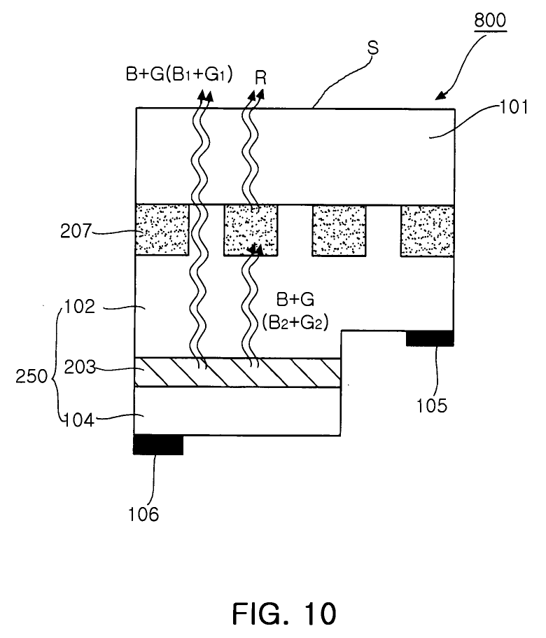

FIG. 10 is a schematic cross-sectional view illustrating a white light emitting device 800 according to further another embodiment of the invention. FIG. 10, which is a modified example of FIG. 9, is identical to FIG. 9 except that light exits through an underside surface S of a substrate 101. Primary radiation B+G and secondary radiation R are obtained substantially the same as in the embodiment of FIG. 9. That is, the primary radiation B+G is generated from an active layer 203 of a light emitting structure 250 and the secondary radiation R is obtained by wavelength conversion film elements 207. A portion B₁+G₁ of the primary radiation B+G is emitted through the underside surface S of the substrate 101 and other portion B₂+G₂ thereof is absorbed in the wavelength conversion film elements 207. The wavelength conversion film elements 207 convert the absorbed portion of the primary radiation B₂+G₂ into the secondary radiation R of a different wavelength. The secondary radiation R is emitted through the underside surface S of the substrate 101 without any change in the wavelength thereof. The primary radiation B₁+G₁ emitted through the underside surface S of the substrate 101 is combined with the secondary radiation R obtained by the wavelength conversion film elements 207, thereby producing white light.

According to the embodiments described above, the wavelength conversion film elements are employed to obtain white light without a package for containing phosphor, thereby minimizing the white light emitting device. Also, the conversion wavelength film is patterned to ensure each LED device to easily produce white light with uniform characteristics. Moreover, a relative ratio between the area of the wavelength conversion film elements and the area of the open region is adjusted to easily control color balance and color combination. In addition, to form the wavelength conversion film elements, the wavelength conversion film is deposited and selectively etched, thereby relatively simplifying a manufacturing process and saving manufacturing costs of the device.

As set forth above, according to exemplary embodiments of the invention, wavelength conversion film elements are adopted to easily control color balance and color combination. Also, a white light emitting diode device of the invention can produce white light only with a single LED chip without a package, thereby reduced in size and simplified in a manufacturing process and manufacturing costs over a conventional LED device. In addition, the area of wavelength conversion film elements can be increased or decreased to produce high quality white light with uniform characteristics.

While the present invention has been shown and described in connection with the preferred embodiments, it will be apparent to those skilled in the art that modifications and variations can be made without departing from the spirit and scope of the invention as defined by the appended claims.

What is claimed is:

1. A white light emitting device comprising:
a substrate;
a light emitting structure including an n-type semiconductor layer, an active layer and a p-type semiconductor layer sequentially formed on the substrate, the light emitting structure emitting primary radiation; and
wavelength conversion film elements for absorbing a portion of the primary radiation and converting the absorbed portion of the primary radiation into secondary radiation of a different wavelength,
wherein the wavelength conversion film elements define an open region for selectively transmitting the primary radiation therethrough.

2. The white light emitting device according to claim 1, wherein the wavelength conversion film elements are formed on the p-type semiconductor layer.

3. The white light emitting device according to claim 1, wherein the wavelength conversion film elements are formed underneath the substrate.

4. The white light emitting device according to claim 1, wherein the wavelength conversion film elements are interposed between the light emitting structure and the substrate.

5. The white light emitting device according to claim 1, wherein the primary radiation is combined with the secondary radiation to produce white light.

6. The white light emitting device according to claim 1, wherein the p-type semiconductor, the active layer and the n-type semiconductor comprise a nitride semiconductor.

7. The white light emitting device according to claim 1, wherein the wavelength conversion film elements absorb at least 90% of the primary radiation incident thereon.

8. The white light emitting device according to claim 1, wherein the wavelength conversion film elements are made of a homogeneous material.

9. The white light emitting device according to claim 1, wherein the wavelength conversion film elements comprise a wavelength convertible, material selected from a group consisting of phosphor, metal silicate, oxide and semiconductor.

10. The white light emitting device according to claim 9, wherein the semiconductor comprises AlGaInP or ZnSe.

11. The white light emitting device according to claim 9, wherein the metal silicate comprises europium-silicate.

12. The white light emitting device according to claim 11, wherein the europium-silicate has a composition expressed by EuₓSi_{y}O_{z}, where 0<x<30, 0<y<30, and 0<z<30.

13. The white light emitting device according to claim 1, wherein the primary radiation comprises blue light, and the secondary radiation comprises light in a range from green to red wavelengths, or yellow light.

14. The white light emitting device according to claim 1, wherein the primary radiation comprises light in a range from blue to red wavelengths, and the secondary radiation comprises red light.

15. The white light emitting device according to claim 1, wherein white light is emitted through a top surface of the light emitting structure which opposes the substrate.

16. The white light emitting device according to claim 1, wherein white light is emitted through an underside surface of the substrate which opposes the light emitting structure.
